(19) United States
(12) Patent Application Publication
(10) Pub. No.: US 2022/0297132 A1
(43) Pub. Date: Sep. 22, 2022

(54) ABRASION RESISTANT DISTRIBUTOR PLATE ASSEMBLY FOR VSI CRUSHER

(71) Applicant: SANDVIK SRP AB, Svedala (SE)

(72) Inventors: Knut KJAERRAN, Svedala (SE); Rowan DALLIMORE, Somerset (GB); Andreas FORSBERG, Malmo (SE)

(21) Appl. No.: 17/432,224

(22) PCT Filed: Feb. 20, 2019
(86) PCT No.: PCT/EP2019/054227

§ 371 Date: Aug. 19, 2021

(51) Int. Cl. B02C 13/18; B02C 13/28

(52) U.S. Cl. CPC B02C 13/1835; B02C 13/28; B02C 2210/02; B02C 2013/28681

(57) ABSTRACT

An abrasion resistant distributor plate assembly mountable within a rotor of a vertical shaft impact crusher to protect the rotor from abrasive wear caused due to material falling on to the rotor. The distributor plate assembly includes a main body, wear-resistant inserts mounted on the main body having a wear resistance greater than the main body, and an elevated central component directly mounted on the main body, which has a wear resistance greater than that of the inserts.

### FIELD OF INVENTION

The present disclosure relates to an abrasion resistant component for vertical shaft impact (VSI) crushers. More particularly, the present disclosure relates to a wear resistant distributor plate assembly for protecting the rotor of the VSI crusher, useful for reducing the wear of the rotor caused by the impact and abrasion of the material fed into the rotor during the operation of the VSI crusher.

### BACKGROUND ART

VSI crushers find widespread use in a variety of crushing applications like mining and construction. These crushers are capable of crushing hard and very abrasive materials like rock, ore, industrial minerals and demolished construction material. A typical VSI crusher comprises a rotor in a housing wherein the rotor is provided with a top aperture through which material to be crushed is fed under gravity. The rotor commonly comprises of a horizontal upper disc and a horizontal lower disc. Since the material flow causes wear of the rotor, a central distributor plate is mounted on the lower disc of the rotor to prevent it from the wear. Wear of the crusher components (like the rotor) adds to the expense of the maintaining and operating the apparatus, as the worn component needs to be identified, inspected, removed and replaced. This also causes operational down-time for the apparatus, as it needs to be shut down for the removal and replacement of the component. Such delays and expenses are compounded if the crusher apparatus is located in a remote location. Hence, there is a need to develop an easy-to-install and economical distributor plate which provides efficient wear-protection for the rotor of the VSI crusher.

An example of a presently used distributor plate is described in the patent document WO2016/206753. One disadvantage with using such plate having ceramic inserts is that, the material flowing under gravity on the plate, impacts at the center of the plate at 90 degrees, causing substantial impact wear which chips away the ceramic tiles from the center of the plates. This significantly reduces the operational lifetime of the plate, because if the center of the plate gets damaged by impact from the material, the whole plate needs to be replaced prematurely.

Another problem with the distributor plate assemblies, is that they are made up of multiple parts which need to be assembled together with the help of screws and bolts. Usually, the distributor plate assembly is mounted on the rotor using one major central bolt, making it difficult for the operator to fasten the assembly into the crusher. Since the construction of the assembly is complicated, the mounting and fastening process is cumbersome and time-consuming, which makes the servicing intervals long. Yet another drawback of some of the known distributor plate assemblies is their heavy weight which makes the manual handling of these plates difficult.

Accordingly, there is needed a distributor plate assembly which provides efficient wear protection to the rotor of the VSI crusher and is also convenient and lighter in weight to assist manual handling and facilitates easy and fast mounting/dismounting at the rotor of the VSI crusher.

### SUMMARY OF THE INVENTION

The aim of the present disclosure is to overcome or at least reduce the above-mentioned drawbacks.

It is an objective of the present disclosure to provide a VSI crusher distributor plate assembly configured to provide effective wear resistance resulting from abrasion due to contact with crushable material during rotor operation. It is yet another objective of the present disclosure to maximize the operational life-time of the distributor plate assembly and to minimize the frequency of maintenance service intervals which disrupt normal crusher operations. A further specific objective of the present disclosure is to provide a distributor plate assembly which is optimized with respect to its weight and is convenient to handle manually and allows easy and quick installation at the rotor and dismounting from the rotor. Another specific objective of the present disclosure is to provide a distributor plate assembly which provides efficient wear protection from the impact of the material falling under gravity specially at the center of the plate (where material falls at 90 degrees to the plate), which would otherwise result in premature replacement of the whole plate.

The objectives are achieved by providing a distributor plate assembly which is specifically configured to have good resistance against abrasive wear resulting from crushable material being guided at high speed to each of the three solid internal rock walls within the rotor. According to a first aspect of the present disclosure, there is provided a distributor plate assembly releasably mountable to protect a rotor of a vertical shaft impact crusher from material fed into the rotor. The assembly comprises a main body with a first component mounted at the main body to form at least part of a contact surface arranged to face material being fed into the rotor. The first component having abrasion resistance greater than that of the main body. Further, a second component is mounted at the main body to form at least part of a contact surface arranged to face material being fed into the rotor. The second component having abrasion resistance greater than that of the first component wherein at least a part of the second component is elevated above an upper contact surface of the first component. The advantage of this embodiment is that the second component being elevated, tougher and more abrasion-resistant protects the first component and the main body from damage due to falling material, thereby increasing the operational lifetime of the distributor plate assembly.

Preferably, the second component is positioned in the center of the assembly. The center of the distributor plate is mounted directly on the main body. Advantageously, the second component renders the distributor plate more impact resistant at the central part and protects the first component which is usually made of ceramic, and the rest of the plate from damage due to impact from material falling perpendicularly under gravity. The second component being elevated, also allows the material to slide down from its periphery which reduces the impact of the material on the first component. This reduces the breakage and possible premature failure of the first component as the material does not hit the first component at a perpendicular angle which causes the maximum impact. The elevation of the second component, also renders the plate capable of being resistant to the abrasion being caused due to material striking the plate from the sides in a radially inward direction.

Preferably, the lower contact surface of the first component and the lower contact surface of the second component are both in physical contact with the upper contact surface of the main body. It is advantageous if both the first and the second components are mounted directly on the main body, as it provides a more stable structure for the distributor plate assembly. This feature makes the distributor plate assembly sturdy as there is no hollow space between the first and second component, or between the second component and the main body. Such an arrangement is advantageous to optimize mechanical and physical characteristics of the distributor plate assembly by providing it high abrasion resistance whilst minimizing the volume of the assembly.

Optionally, the first component and the second component are mounted on the main body using an adhesive. This is advantageous as there is no need to have bolts and screws to hold together the first component, the second component and the main body. Accordingly, with the adhesive, the assembly is in the form of a single integrated unit. It is therefore easy to handle for the operator as it does not involve the need to screw-in multiple components at the time of mounting the distributor plate assembly at the crusher. This feature is advantageous as it reduces the weight of the assembly since there is no need to have screws and bolts to fit the components together, thereby also reducing the overall cost of the assembly, while also making the assembly compact.

Optionally, the first component comprises a plurality of non-metallic wear resistant tiles having substantially the same shape and size arranged to be in physical contact with the second component in such a way that the edges of the second component mate with the edges of the first component. Optionally, the tiles may be formed from abrasion resistant inserts of different shapes and sizes dependent upon their position at the main body relative to the material flow path over the plate. Preferably, the first component is made up of non-metallic wear resistant composite tiles comprising a ceramic or other carbide material. Optionally, the first component comprises aluminium oxide ceramic. More specifically the tiles may comprise any one or combination of aluminium oxide (alumina), zirconium oxide (zirconia), silicon carbide, boron carbide, silicon nitride or boron nitride. These materials offer the advantage of high abrasion resistance while reducing the overall weight of the distributor plate assembly, making it convenient for manual handling.

Optionally, the second component is in the shape of a truncated star with substantially planar upper contact surface. The advantage of having the second component in the shape of a truncated star is that the edges of the star-shaped second component establish physical contact with the edges of the tiles in the first component rendering the structure stable. Another advantage of the star-shape is that it aligns perfectly with ceramic tiles which are preferably used for the first component, and which are easily available commercially and are cost-effective. The upper contact surface of the star-shaped second component is planar.

Preferably, the main body predominantly comprise mild steel. Advantageously enables a firm main body of the distributor plate assembly that may lodge the wear resistant tiles.

Optionally, the main body comprises nodular iron which advantageously enables an alternative main body of the distributor plate assembly that may lodge the wear resistant tiles.

Preferably, the second component comprise tungsten carbide. Advantageously this is added as a top layer over the mild steel or nodular iron to enable a high abrasion resistance.

The thickness of the main body may be at least 5 mm.

Optionally, the thickness of the second component in the vertical direction is the same or greater than the thickness of the first component. Preferably, the thickness of the first component may be at least 15 mm and the thickness of the second component may be 15 mm or greater. A configuration provided with an elevation of the second component may have a greater abrasion resistance than the first component and the main body of the assembly, against material falling under gravity, at 90 degrees to the distributor plate assembly. The elevation may also allow the downward passage of the material from the periphery of the second component in such a way that this sliding motion reduces the impact of the falling material on the first component thereby reducing the breakage of the first component and increasing the operational lifetime of the distributor plate assembly.

According to a second aspect of the present disclosure, the second component is of circular shape such as a puck with peripheral slope which facilitates the passage of the falling crushable material on to the first component. The puck-shape offers the advantage of ease of sliding of the falling material from all sides of the second component. This sliding motion reduces the impact of the falling material, especially the material falling at 90 degrees to the distributor plate assembly. Reduced impact translates into reduced breakage of the first component which thereby increases the operational lifetime of the distributor plate assembly and also minimizes the frequency of maintenance/repair intervals which cause the machine to shut down temporarily.

Optionally, the distributor plate assembly is configured to be capable of releasably locking at the rotor via attachment components which are preferably positioned on the periphery of the main body of the distributor plate assembly to cooperate with the attachment elements on the rotor for releasable clamping. Attachment components may include lugs and clamping brackets with bolts for holding down the plate.

Optionally, a vertical shaft impact crusher rotor comprises a distributor plate assembly as described above. It is an advantage that the distributor plate assembly is provided with peripherally positioned attachment components for mounting at the rotor, because it allows easy attachment without the need of any central bolt. Since there are no screws and bolts needed to mount the plate assembly, the mounting and dismounting process is very easy and convenient for the operator. This also reduces the cost of the distributor plate assembly as there are fewer components involved. As a result of this configuration, the distributor plate assembly has optimized weight and physical dimensions.

Optionally, a vertical shaft impact crusher comprising a rotor having a distributor plate assembly as described above. The advantage is a more effective vertical shaft impact crusher that will last longer due to the use of the distributor plate assembly which will render a more abrasive rotor.

Other aspects and advantages of the present disclosure will be more apparent from the following description, which is not intended to limit the scope of the present disclosure.

### BRIEF DESCRIPTION OF DRAWINGS

Some embodiments of the invention will be explained in greater detail with reference to the accompanying drawings in which:

FIG. 1 shows an external perspective view of a VSI crusher rotor having upper and lower discs separated by wall sections according to a specific implementation of the present disclosure;

FIG. 2 shows a perspective view of the rotor of FIG. 1 with the upper disc and one of the walls and wear plates removed for illustrative purposes;

FIG. 3 shows a plan view of the rotor of FIG. 1 with the upper disc and one of the walls and wear plates removed for illustrative purposes;

FIG. 4 shows a perspective view of the central distributor plate assembly according to one of the preferred embodiments of the present disclosure;

FIG. 5 shows a plan view of the central distributor plate assembly according to one of the preferred embodiments of the present disclosure;

FIG. 6 shows a vertical cross-sectional view of the central distributor plate assembly according to one of the preferred embodiments of the present disclosure;

FIG. 7 shows an exploded perspective view of the central distributor plate assembly according to one of the preferred embodiments of the present disclosure;

FIG. 8 shows a perspective view of the central distributor plate assembly according to one of the preferred embodiments of the present disclosure;

FIG. 9 shows a plan view of the central distributor plate assembly according to one of the preferred embodiments of the present disclosure;

FIG. 10 shows a side view of the central distributor plate according to one of the preferred embodiments of the present disclosure;

FIG. 11 shows a vertical cross-sectional view of the central distributor plate assembly according to one of the preferred embodiments of the present disclosure and;

FIG. 12 shows an exploded perspective view of the central distributor plate assembly according to one of the preferred embodiments of the present disclosure

### DETAILED DESCRIPTION OF PREFERRED EMBODIMENT OF THE INVENTION

The present disclosure will now be described with reference to the accompanying embodiments which do not limit the scope and ambit of the disclosure. The description provided is purely by way of example and illustration.

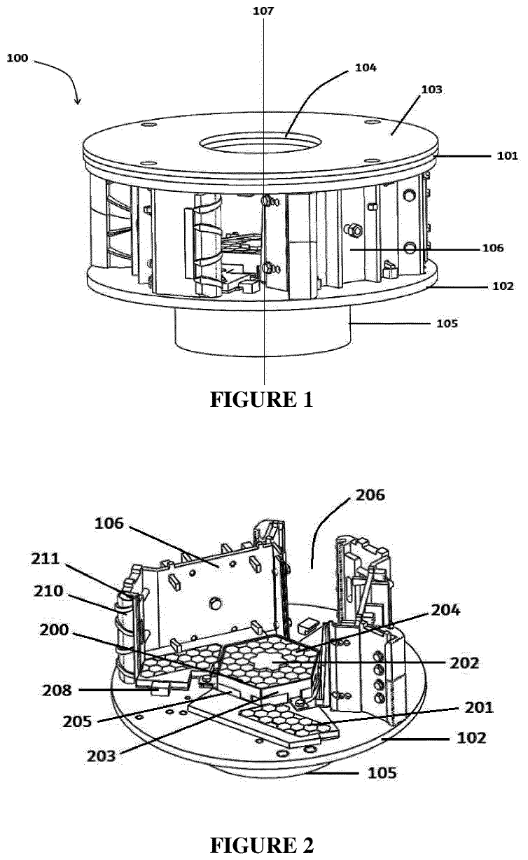

Referring to the FIG. 1, a rotor 100 of a vertical shaft impact (VSI) crusher comprises a roof in the form of an upper horizontal disc 101 having an upper wear plate 103, and a floor in the form of a lower horizontal disc 102. The rotor 100 rotates along a longitudinal axis 107. The upper and lower discs 101, 102 are separated by walls 106 that channel the flow of the material passing through rotor 100. The lower disc 102 is welded to a hub 105 that is in turn connected to a vertical shaft (not shown) for rotating rotor 100 within a main housing (not shown) of the VSI crusher. Upper disc 101 has a central aperture 104 through which material to be crushed may be fed into rotor 100. Upper horizontal disc 101 is protected from crushable material impacting the rotor 100 from above by a top wear plate 103.

FIG. 2 illustrates rotor 100 with upper disc 101 and a part of wall 106 removed for illustrative purposes. Both the upper and lower discs 101 and 102 respectively, are protected from wear by three wear plates 201 (only two are illustrated on lower disc 102 in FIG. 2).

Gaps between the rotor walls 106 define outflow openings 206, through which material may be ejected against a housing wall (not shown). At each outflow opening 206, the respective rotor wall 106 is protected from wear by a wear tip 211 located at the leading edge of the respective rotor wall 106. Each wear tip 211 is mounted to the respective rotor wall 106 by means of a wear tip holder 210. The distributor plate assembly 200 is mounted centrally above hub 105 so as to be elevated above lower disc 102. The distributor plate assembly 200 is configured to distribute the feed material received through the aperture 104 and to protect the lower disc 102 from wear and impact damage caused by the abrasive contact with the feed material. Distributor plate assembly 200 is modular in the axial direction and comprises a main body 203, wear resistant inserts 204 embedded preferably in the form of tiles in the main body 203, and an elevated wear-protection component 202 the edges of which are aligned with the edges of the tiles 204. The distributor plate assembly 200 is releasably mounted over the rotor 100 by a plurality of attachment components 207, which are positioned at and around an outside perimeter of the distributor plate assembly 200 and provide a mechanism for attaching the assembly 200 to the rotor 100 and in particular hub 105. The spacer plate 205 is present to provide an indirect mount for the distributor plate assembly 200 at the rotor 100.

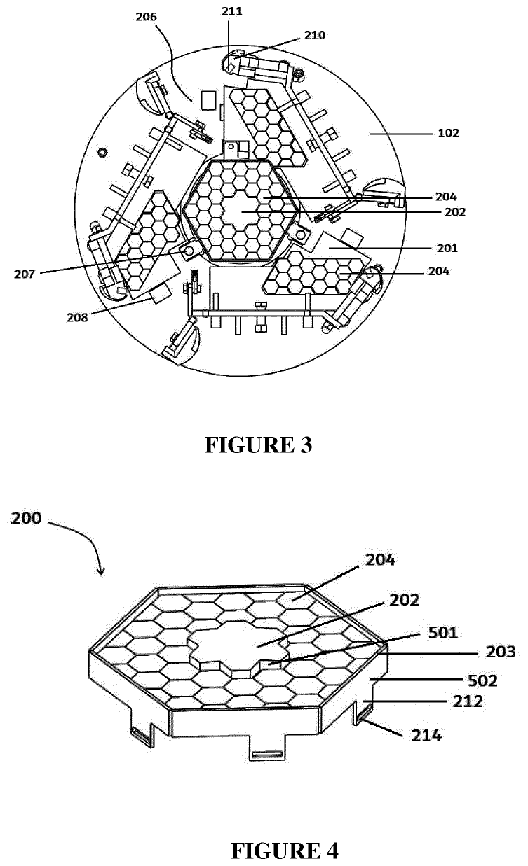

Referring to FIG. 3, wear plates 201 are positioned to at least partially surround the perimeter of distributor plate assembly 200 and at least partially cover the exposed surface of the lower disc 102. The three wear plates 201 are positioned radially around the perimeter 213 of the distributor plate assembly 200. Each wear plate 201 is generally elongate and extends in a part circumferential path along the lower disc 102 so as to provide a wear surface over which material may flow in a radially outward direction. Each wear plate 201 is maintained in position at the lower disc 102 by a right-angle bracket 208. To increase the wear resistance, each plate 201 comprises a plurality of wear resistant inserts 204. Preferably, these inserts 204 are in the form of tiles and are of the same composition as the inserts 204 of the distributor plate assembly 200. Preferably, the inserts 204 are of substantially the same shape and/or size. According to a preferred embodiment, the inserts 204 are made up of non-metallic wear resistant composite tiles comprising a ceramic or other carbide material. According to an embodiment, the inserts 204 comprise an aluminium oxide ceramic. According to further embodiments, the inserts 204 may comprise zirconia or a non-tungsten carbide or nitride such as silicon carbide, boron carbide, silicon nitride and boron nitride, all of which provide high abrasion resistance while reducing the overall weight of the distributor plate assembly, making it convenient for manual handling. According to one of the embodiments, the elevated component 202 is in the shape of a truncated star, with its edges 301 mating with the edges 501 of the hexagonal tiles 204. The distributor plate assembly 200 is releasably locked at the rotor 100 via three attachment components 207.

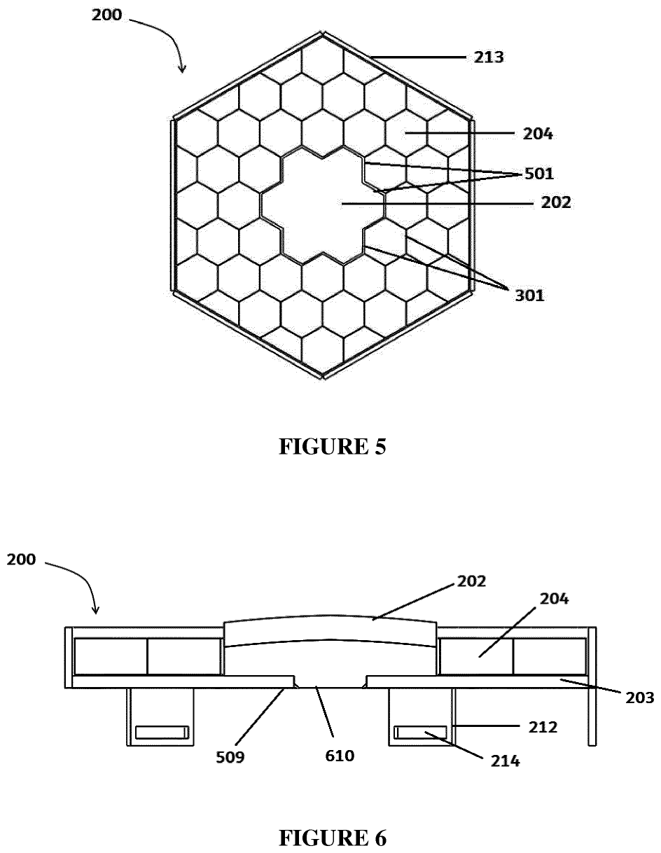

Referring to FIGS. 4 and 5, the distributor plate assembly 200 is shown to comprise of the main body 203 defined by the periphery 213, the elevated wear-resistant component 202 in the center along with wear-resistant inserts 204 in the form of hexagonal tiles surrounding the elevated component 202, according to one of the preferred embodiments of the present disclosure. The inserts 204 are arranged in such a way that the edges 501 of the elevated component 202 are in physical alignment with the edges 301 of the inserts 204. According to one of the embodiments, both the elevated component 202 and the inserts 204 are mounted on to the main body 203 in such a way that the lower contact surface of the elevated component 202 and the lower contact surface of the tiles 204 are in physical contact with the upper contact surface of the main body 203. Preferably, the elevated component 202 and the tiles 204 are mounted on the main body 203 with the help of an adhesive. Preferably, main body 203 comprises mild steel or nodular iron. Preferably, the elevated component 202 comprises tungsten carbide. The main body 203 as shown in FIGS. 4 and 5, has a hexagonal shape with six edges 502 defining the periphery or the outer perimeter 213 of the main body 203. At each edge 502, there is provided an attachment component 212 in the form of a lug projecting axially downwards from the edge 502 so as to extend below a downward facing surface 509 (shown in FIG. 6) of the main body 203. Each lug 212 is radially spaced apart along the perimeter 213 of the main body 203. with an elongate slot 214 to accommodate the corresponding attachment component for fixing the assembly 200 to the rotor 100.

FIG. 6 shows the vertical cross section of the distributor plate assembly 200 with the elevated component 202 shown to be non-detachably coupled to the main body 203 without the need of any physical mounting components like nuts, bolts and screws. The elevated component 202 makes direct physical contact with the main body 203 at the center 610 of the main body 203. Similarly, the inserts 204 are also directly attached to the main body 204 with the help of an adhesive, and without any physical mounting components. This is an advantage because not only does the lack of mounting components reduce the overall weight of the distributor plate assembly 200, but also makes the assembly 200 a single integrated unit which is easy and convenient to mount and dismount from the rotor 100.

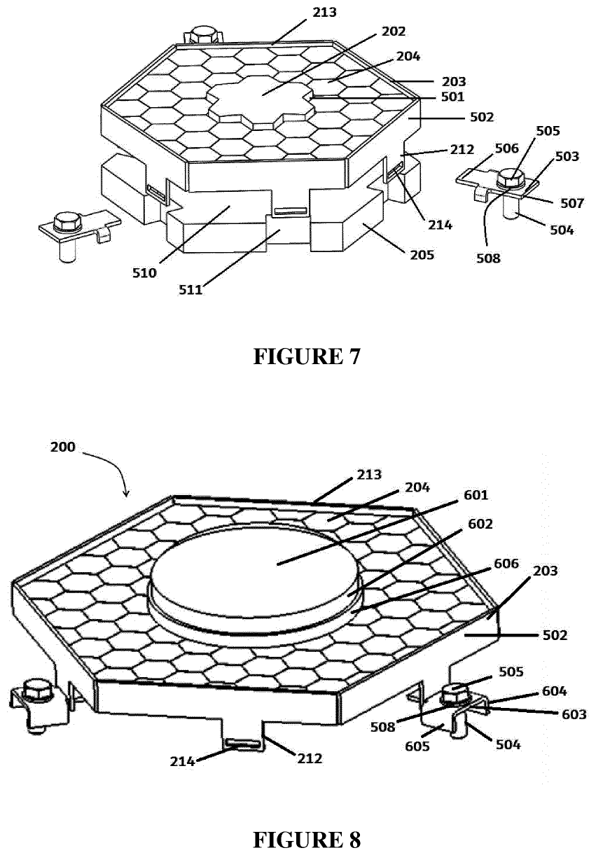

Referring to FIG. 7, an attachment component 503 is shown in the form of a flange which enters the slot 214 of the lug 212 to enable locking of the distributor plate assembly 200 on to the rotor 100. The slot 214 is dimensioned to receive a first end 506 of the plate-like flange 503. A second end 507 of the flange 503 comprises an aperture 508 to receive a threaded shaft 504 of bolt 505 for engaging with the body of the rotor 100. When the flange 503 enters the lug 212, the distributor plate assembly is releasably clamped in place on top of the rotor 100. In the FIG. 7, the distributor plate assembly 200 is shown together with the spacer plate 205, which is provided with notches 511 in the form of recesses on its perimeter 401 of the spacer plate 205. These notches 511 provide clearance for the lowermost regions of the lugs 212 and the end 506 of the flange 503. The distributor plate assembly 200 is mated against the spacer plate 205 via contact between the upward facing planar surface 510 of the spacer plate 205 and the downward facing planar surface 509 of the main body 203 of the distributor plate assembly 200.

According to another embodiment of the present disclosure, the elevated component 601 in the center is in the shape of a puck, as shown in FIG. 8. The distributor plate assembly 200 comprises of a main body 203 with its six edges 502 defining the perimeter 213 of the hexagon as shown in FIG. 8. The assembly 200 further comprises wear-resistant inserts 204 in the form of hexagonal tiles, mounted on to the main body 203 of the assembly 200. Further, from the edges 502 of the main body 203, project downwards, the lugs 212 with elongate slots 214 for releasably engaging with flanges 503 to clamp the distributor assembly 200 on to the rotor 100. As can be seen in FIG. 8, there is a bracket 603 with its two ends 604 and 605 bent downwards, to be able to engage with the body of the rotor for holding the assembly 200 in place. There is provided a bolt 505 which enters the bracket 603 through an aperture 508. The puck 601 has a peripheral slope on its edge 602 which facilitates the downward passage of the material to be crushed, on to the inserts 204. The puck 601 is welded to another material 606 which establishes direct contact with the main body 203.

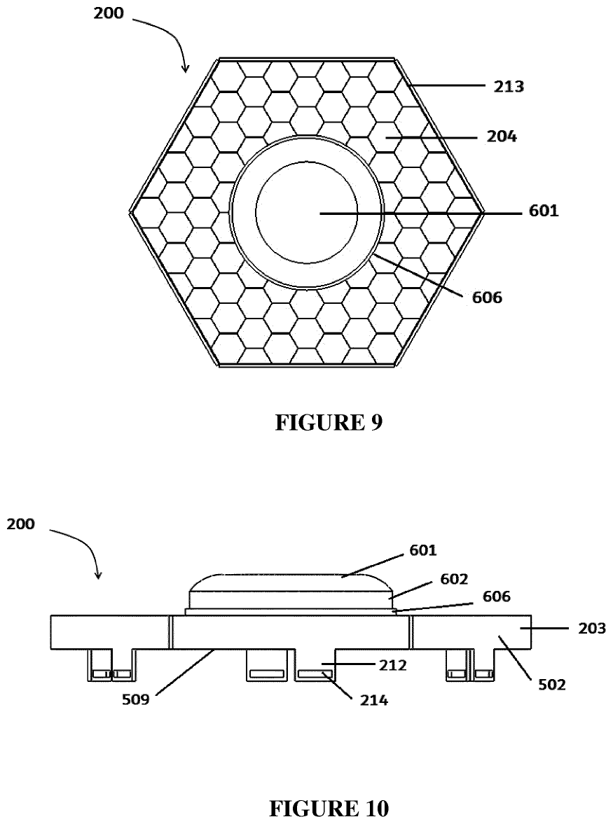

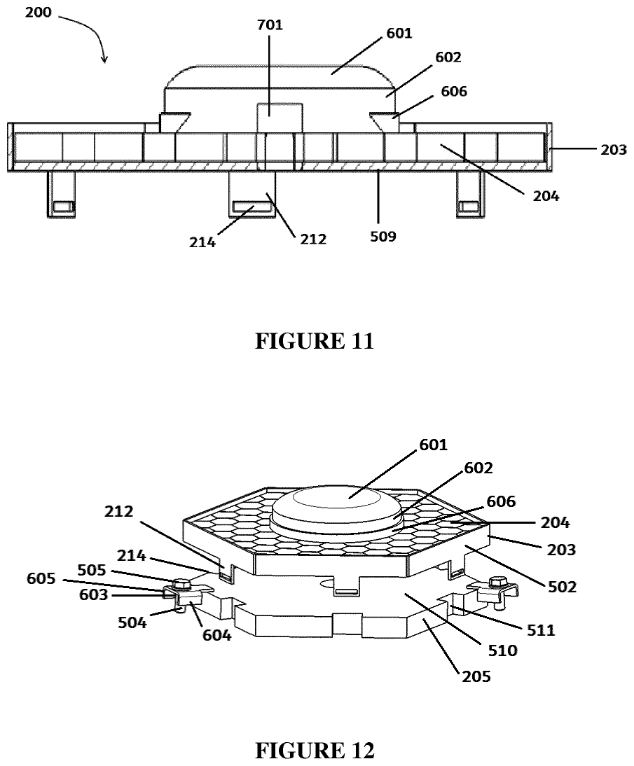

Referring to FIG. 9 and FIG. 10, the puck 601 can be seen mounted on the main body 203 at the center. The edge 602 of the puck 601 is in contact with the edges 301 of the insert 204. The puck 601 comprises a part 606 which comprises of another material and is welded with the puck 601. As can be seen in the figure, the part 606 is in direct contact with the upper contact surface of the inserts 204, is welded to the body of the puck 601. Projecting downwards from the edge 502 of main body 203 are lugs 212 with elongate slots 214 for facilitating engagement with flanges 503 which have dimensions corresponding to the slots 214. FIG. 11 shows the vertical cross-section of the distributor plate assembly 200 with the elevated component 601 at the center being in the shape of a puck. The puck 601 is mounted on the main body 203 with the aid of a bolt 701 which affixes the puck 601 to the center of the main body 203. The puck 601 is welded together with a material 606 which is different from the rest of the body of the puck 601. The material 606 is contact with the upper surface of the inserts 204 which are in direct contact with the main body 203. The lugs 212 having elongate slots 214, project downwards from the main body 203, extending below the downward facing surface 509 of the main body 203.

Referring to FIG. 12, a puck 601 is seen welded to another material 606 which is in mounted on the main body 203. The wear-resistant inserts 204 are also mounted on the main body 203, and establish direct physical contact with the main body 203. The inserts 204 surround the elevated puck 601 which is located at the center of the main body 203. The spacer plate 205 is present to provide an indirect mount for the distributor plate assembly 200 at the rotor 100. The spacer plate 205 is provided with notches 511 in the form of recesses on the periphery of the plate 205, to accommodate the lugs 212 and brackets 603 which engage with the lugs 212. The bracket 603 has two ends 604 and 605 bent downwards, to be able to engage with the body of the rotor 100 for holding the assembly 200 in place. There is provided a bolt 505 which enters the bracket 603 through an aperture 508.

Although a few embodiments of the present invention have been shown and described, it would be appreciated by those skilled in the art that changes may be made in these embodiments without departing from the principles and spirit of the disclosure, the scope of which is defined in the claims and their equivalents.

1. A distributor plate assembly releasably mountable to protect a rotor of a vertical shaft impact crusher from material fed into the rotor, the assembly comprising;
a main body;
a first component mounted at the main body to form at least part of a contact surface arranged to face material being fed into the rotor, the first component having an abrasion resistance greater than an abrasion resistance of the main body; and
a second component mounted at the main body to form at least part of the contact surface arranged to face material being fed into the rotor, the second component having an abrasion resistance greater than an abrasion resistance of the first component, wherein at least a part of the second component is elevated above an upper contact surface of the first component.

2. The assembly as claimed in claim 1, wherein the second component is positioned in a center of the assembly.

3. The assembly as claimed in claim 1, wherein the upper contact surface of the first component forms at least a part of the contact surface and wherein the second component has an upper contact surface forming at least a part of the contact surface arranged to face material being fed into the rotor, a lower contact surface of the first component and a lower contact surface of the second component being in physical contact with an upper contact surface of the main body.

4. The assembly as claimed in claim 1, wherein the first component comprises a plurality of non-metallic wear resistant tiles having substantially the same shape and size arranged to be in physical contact with the second component in such a way that the edges of the second component mate with the edges of the tiles of the first component.

5. The assembly as claimed in claim 1, wherein the second component is in the shape of a truncated star, the upper contact surface thereof being substantially planar.

6. The assembly as claimed in claim 1, wherein the second component has a circular shape such as a puck having a peripheral slope.

7. The assembly as claimed in claim 1, wherein a thickness of the second component in a vertical direction is the same or greater than a thickness of the first component.

8. The assembly as claimed in claim 1, wherein the main body predominantly comprises mild steel.

9. The assembly as claimed in claim 1, wherein the main body comprises nodular iron.

10. The assembly as claimed in claim 1, wherein the first component comprises aluminium oxide ceramic.

11. The assembly as claimed in claim 1, wherein the second component comprises tungsten carbide.

12. The assembly as claimed in claim 1, wherein the first component and the second component are mounted on the main body using an adhesive.

13. The assembly as claimed in claim 1, wherein the assembly is in the form of a single integrated unit.

14. A vertical shaft impact crusher rotor comprising a distributor plate assembly as claimed in claim 1.

15. A vertical shaft impact crusher comprising a rotor as claimed in claim 13.
